(19) United States
(12) Patent Application Publication
(10) Pub. No.: US 2025/0199825 A1
(43) Pub. Date: Jun. 19, 2025

(54) USE-CONSTRAINED USER INTERFACE COMPONENT DISTRIBUTION

(71) Applicant: Wells Fargo Bank, N.A., San Francisco, CA (US)

(72) Inventor: Krishnappan Muthuraman, Charlotte, NC (US)

(21) Appl. No.: 18/541,723

(22) Filed: Dec. 15, 2023

(51) Int. Cl. G06F 9/451

(52) U.S. Cl. CPC G06F 9/451

(57) ABSTRACT

System and techniques to provide use constraints when distributing user interface component are described herein. A request for a user interface component is received with a call context. This call context is matched to a local use context that embodies constraints on use of the UIC. Corresponding call context values are compared to the use context to determine whether the use of the user interface component is compliant. If the use is compliant, the user interface component is served in response to the request; otherwise the user interface component is not served.

### TECHNICAL FIELD

Embodiments described herein generally relate to computer interface frameworks and more specifically to use-constrained user interface component distribution.

### BACKGROUND

A computer user interface (UI) enables a user to interact with a computer system through elements and components, such as buttons, images, text, prompts, etc. A typical UI uses windows, icons, menus, pointer (WIMP) elements to enable intuitive engagement. The UI presents information and choices to the user via dialog boxes, menus, and toolbars and receives user input through devices like a keyboard, mouse, touch screen, etc. UI elements usually follow design principles focused on usability, discoverability, responsiveness, and aesthetics. Effective UIs can use metaphors, mental models and affordances to create clarity and guide the user. UIs can be implemented in hardware and software across operating systems, programs, websites, and devices. Advanced UIs can use other technologies, such as artificial intelligence (AI), augmented reality (AR), or virtual reality (VR) to provide adaptive, immersive, or conversational experiences.

A micro front-end (MFE) is a decentralized approach to building user interfaces. An MFE can be a self-contained component that is independently developed, deployed, or maintained separate from the rest of the application. An MFE usually encapsulates the UI and business logic for a specific feature or workflow of the application. For example, an e-commerce site can have separate MFEs for a product catalog, a shopping cart, and checkout. MFEs generally communicate via APIs and events. This enables different development groups (e.g., teams, companies, etc.) to develop MFEs independently without coordination. MFEs often provide greater flexibility to update parts of a UI without impacting the codebase of the rest of an application. The modular architecture also enables selectively embedding MFEs where needed across platforms, such as on the web, a mobile device application, a desktop computer, etc.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a block diagram of an example of an environment including a system for use-constrained user interface component distribution, according to an embodiment.

FIG. 2 illustrates an example of an architecture to serve user interface components, according to an embodiment.

FIG. 3 illustrates examples of signal exchanges to publish and consume user interface components, according to an embodiment.

FIG. 4 illustrates a flow diagram of an example of a method for use-constrained user interface component distribution, according to an embodiment.

FIG. 5 is a block diagram illustrating an example of a machine upon which one or more embodiments can be implemented.

### DETAILED DESCRIPTION

While implementing a UI, in whole or part, with an MFE often brings increased flexibility to implement new features or revise old features, there is often a cost paid in complexity. This complexity emerges from maintaining a library of MFEs that application developers can use, enabling the selection of MFEs from such a library, or from distributing MFEs for operation. The distribution of the MFEs can often include computer services to serve MFE code or perform MFE calculations and produces results that are composited by the UI integrating the MFEs (e.g., a web browser displaying Web Components MFEs).

Another set of complexities that can arise stems from the context for which an MFE was created and the possibility of the MFE can be deployed in another context that is not appropriate. For example, consider an MFE for authentication developed in the context of a managed network, such as is often the case in a school or company. Such an MFE might employ techniques that are not as strong (e.g., have greater vulnerabilities) than other techniques, because the techniques used are easier to implement or use fewer resources. This can be appropriate when, for example, the network management mitigates the vulnerabilities of these techniques. Now, if such an MFE were adopted for a less secure network, such as the Internet, the MFE can expose the application to exploitation by a malicious party.

To address the issues with MFE deployments noted above, use-constrained user interface component (e.g., MFE) distribution can be employed. Here, a service that provides MFEs to requesting parties accepts a call context as part of the MFE request. The call context is compared to a stored use context for the MFE. The call context is within parameters defined by the use context, then the service provides the MFE to the requestor. When the call context includes a value that is beyond the parameters defined by the use context, then the service does not serve the UI component, but rather provides an error message.

In an example, the use context is established as part of a publishing pipeline. Thus, when a UI component developer wants to make the UI component available for service, the UI component is published to the service. The publication can include a review. Although a human reviewer can be involved in the review, the service, or a publishing service, can include an automated review. Such reviews can check included libraries against a list of acceptable libraries, can check for bounds checking on inputs, or appropriate outbound connections including error logging or reporting. In an example, some or all of the use context can be supplied by the developer during publication. The details in the use context can change the behavior of the machine review by, for example, changing the list of acceptable libraries depending upon a managed network context or an unmanaged network context. In an example, the review can impose one or more use context parameters as well. Other use context parameters can be implemented by runtime systems. For example, a call volume, or bandwidth, can be established as part of the use context depending on server loads that are implementing a request UI component. Additional details and examples are described below.

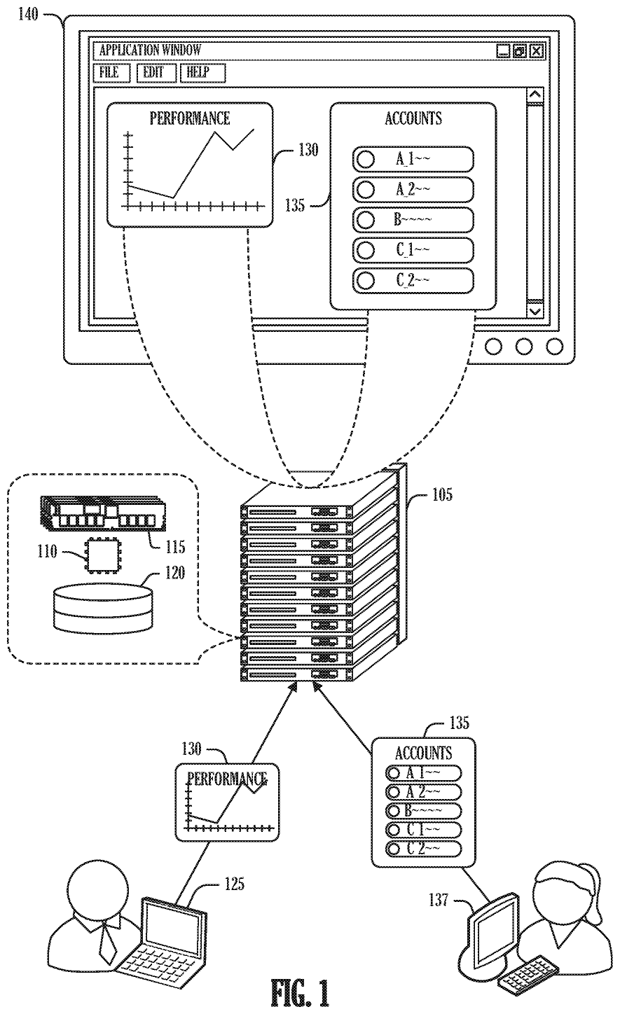

FIG. 1 is a block diagram of an example of an environment including a system 105 for use-constrained UI component distribution, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is generally discarded between system power cycles or restarts. The memory 115 and the storage 120 are both forms of computer readable media. The system 105 can also include one or more network interfaces to connect to other computer systems, such as the laptop 125, the desktop 137, and the tablet 140. Other computing systems that can connect to the system can include mobile phones, or televisions among others. Generally, each of the other computing systems also include processing circuitry, memory, storage, and a network interface.

As illustrated, the tablet 140 is a consumer of an interface that includes two UI components, a graph component 130, and an account selection component 135. These components are examples of a large number of possible UI components. Other examples can include a login component, checklist component, message component, menu component, or any number of other discreet UI elements. Also, as illustrated, the graph component 130 is submitted to the system 105 by the laptop 125 and the account selection component 135 is submitted to the system 105 by the desktop 137. This represents the ability of different developers or teams to independently craft UI components that are then integrated into the UI by the tablet 140.

In the context of the system 105 mentioned above, the system 105—e.g., by instructions in the memory 115 configuring the processing circuitry 110—performs use-constrained UI component distribution by verifying that a use of a UI component by a UI is appropriate. Thus, the processing circuitry 110 is configured to receive a request for a UI component (e.g., the graph component 130) from the tablet 140. As noted above, the UI component is one of multiple UICs (e.g., the account selection component 135, among others) hosted by the system 105 and these individual UI components are composable into a user interface. Here, composable means that the components have application programming interfaces (APIs), or other interfaces that enable the UI to integrate the UI component into the UI. MFEs are an example of such composable UI components. In an example, the UI component is a Web Component based on a World Wide Web Consortium (W3C) family of standards. In an example, the request is based on a Hypertext Transfer Protocol (HTTP) request.

The request for the UI component from the tablet 140 identifies the UI component, such as via a universal resource identifier (URI), and also includes a call context. The call context can be included in the request, as part of a header for the request, or via another field that can be defined with respect to the request. In an example, the call context can be part of a related transmission that identifies the request such that the processing circuitry 110 is configured to match the call context with the request. The call context includes one or more elements with values. The values are associated to fields by name (e.g., via a dictionary or similar data structure) or index. In an example, the index is defined before the transmission such that each index position is defined in both the system 105 and the tablet 140 to be the application identifier, for example. In an example, the index is defined in a manifest that is delivered as part of the call context. For the following discussion, it is assumed that the call context has a first element corresponding to the application making the request, and that the first element has a first field name and a first field value.

Once the call context is received, the processing circuitry 110 is configured to retrieve (e.g., from the storage 120) a use context for the UI component. The use context defines the operating parameters for which the UI component is appropriate. These parameters can be ranges (e.g., 50-100 requests a minute), lists (e.g., a list of acceptable or unacceptable network security for the tablet connection), or values (e.g., a type of application such as internal or customer application). In an example, the parameters (e.g., the first element) can correspond to a physical location. In an example, parameters can include a list of other elements in the user interface. In an example, the parameters can include a list of elements that can be (e.g., either are allowed to be or are technically compatible) composed with the UI component. The contra is also possible. Thus, in an example, the parameters can include a list of elements that cannot be composed with the UI component. The use context has a second element that includes a second field name and a second field value. Here, the terms “first element” and “second element” refer to the same logical element held at the two different computer system and does not imply any particular ordering upon these elements.

In an example, the use context also includes additional information intended to be consumed by a human actor. Such information can include explanations of the operation of the UI component, the team that developed the component, service level agreements (SLAs), or other data often included in distributed software, such as a frequently asked question (FAQ) listing. When browsing the UI components hosted by the system 105, developers can consume this additional information to inform decisions on whether a given UI component is appropriate for the application being developed.

The processing circuitry 110 is configured to locate the first element from the call context based locating the first field name using the second field name. Here, the elements available in the use context govern which of the call context values are used. Thus, if the call context included three elements and the use context included two elements, the call context element that does not have a corresponding use context element would be ignored. Once the names present in the use context are located in the call context, the values of the call context elements are available (e.g., can be retrieved) by the processing circuitry 110.

Once the values from the call context are available (e.g., the first field value is found in the call context by matching the second field name with the first field name), the processing circuitry 110 is configured to compare the first field value to the second field value to determine whether the first field value meets, or does not meet, the second field value. Here, whether the first field value meets the second field value is dependent upon the type of parameter represented by the second field value. In an example, if the second field value is a range, and the first field value meets the second field value when the first field value is within the range; otherwise, the first field value does not meet the second field value. In an example, if the second field value is an alphanumeric value, the first field value meets the second field value if the first field value has a degree of difference to the alphanumeric value that is beyond a predetermined threshold. Thus, if the threshold is zero, or missing, the first field value matches the second field value. However, if the second field value has, for example, a regular expression, or a ±value, then the first field value meets the second field value if the first field value matches the regular expression or is within the ±value. In an example, if the second field value is a list, then the first field value meets the second field value by matching elements of the list. Generally, if the list is an exclusion list, then the presence of any element from the list in the first field value means that the first field value does not meet the second field value. Other types of lists, have different matching criteria. For example, if the list is a requirements list, then the first field value including all elements in the list means that the first field value matches the second field value.

The processing circuitry 110 is configured to transmit a failure message in response to the request based on the first field value not meeting the second field value. Otherwise, the processing circuitry 110 is configured to distribute the UI component to the tablet 140. Because the use context defines appropriate operating conditions for the UI component, and the call context defines an operating environment into which the UI component will be used, the processing circuitry 110 can effectively limit the distribution of the UI component based on these contexts.

Because the system 105 participates in the requests made during construction of the UI, the system 105 is conveniently located to track aspects of the UI component use. In an example, the processing circuitry 110 is configured to record telemetry of requests for the UI component, for example, in the storage 120 or in the memory 115. In an example, the telemetry includes a representation of an element in the call context. For example, the representation can include an average of a numerical value, a summary or hash of textual information, a code that corresponds to a geographical location, etc. The representation can also be the same as the value in the element of the call context. In an example, the telemetry includes a representation of data in the request and not in the call context. This example address such things as HTTP headers in an HTTP request (e.g., what type of browser is making the request), headers in the request, etc. In an example, the telemetry includes a representation of data that is not in the request. This example includes such things as the requesting machine, network latency, frequency of request, etc.

Telemetry can reveal, or be combined with other data, to reveal UI component life cycles. Events in such life cycles can include development efficiency (e.g., in time, labor hours, money, etc.), update frequency, reported error, use (e.g., in applications, total requests, processor cycles consumed, etc.). among other things. Such lifecycle data can be used to recommend high-performing UI components to development teams enabling data-driven success for such applications.

Publishing the UI component to the system 105 provides an opportunity for development teams to provide definitions for the use context. Elements of the use context can also be defined by administrators of the system 105 separately from of the developers. Accordingly, in an example, the processing circuitry 110 is configured to receive a registration request for the UI component. In the illustrated example, the registration request would come from the laptop 125 for the graph component 130 or from the desktop 137 for the account selection component 135. In an example, the registration request includes some (e.g., a portion) or all of the use context. In an example, elements of the use context in the registration request can be compared by the processing circuitry 110 to a deployment standard. Here, the deployment standard can be provided to the system 105 by a manager of the system 105. The deployment standard enables standards compliant deployments of a variety of UI components. Thus, the processing circuitry 110 is configured to determine whether a third element of the use context does meet the deployment standard. If yes, then the UI component is registered with the system 105 and is available for deployment. If no, then the processing circuitry 110 is configured to communicate a failure to register the UI component message based on the third element not meeting the deployment standard.

The deployment standard can be configured to verify a number of elements of the UI component. For example, the deployment standard can provide the basis for an automated source code verification. Here, the registration request includes source code for a portion of the UI component and the communication of the failure is based on the source code deviating from the deployment standard.

The present lack of UI component (e.g., MFE) registries and distribution server can hamper the use and integration of UI components in, for example, an organization. Using use-constrained distribution enables a central repository to browse UI components for an application while maintaining controls over appropriate contexts for use of the UI components in a manner missing from current approaches. Other advantages of the centralized repository described herein include a unified (e.g., streamlined) interface (e.g., a web interface) to interact (e.g., publish or subscribe) to UI components, mapping between UI components and applications, the ability to quickly identify redundant work (e.g., duplicate UI components), and a centralized place to gather telemetry data on the UI component ecosystem.

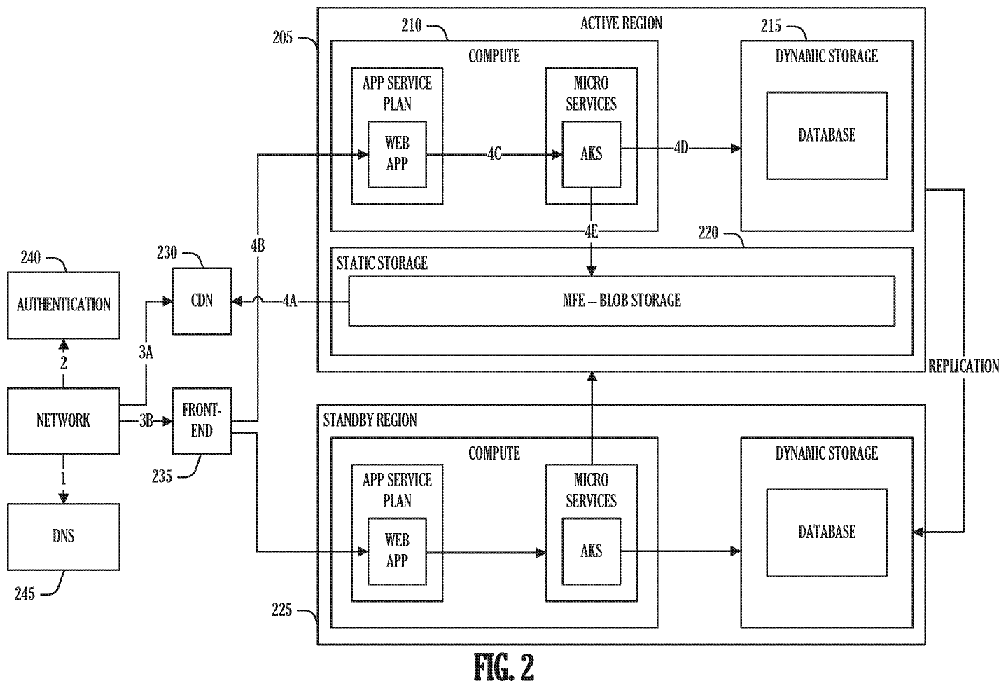

FIG. 2 illustrates an example of an architecture to serve user interface components, according to an embodiment. The active region cloud 205 includes a compute node 210, a structured storage node 215 (e.g., indexed database) and an unstructured storage node 220 (e.g., filesystem, blob storage, etc.). These elements are duplicated, in whole or part, in a standby region cloud 225 that provides redundancy of data or additional compute, of which the compute can be mediated by the load-balancing front-end 235. The unstructured storage node 220 generally maintains static files that do not generally change between requests, such as static Hypertext Markup Language (HTML) pages, configuration files, etc. Such files are often efficiently communicated to end-points through a content data network (CDN) 230 to enable efficient localization of caches towards request locations. The structured storage node 215 generally maintains data for which lookup speed is important or that is subject to regular change, such as an account balance. The compute node 210, hosts the processing of UI components. As illustrated, this processing entails the framework for a web application as wells as a microservice to support the logic contained in the UI component.

A path for serving a UI component through the illustrated architecture begins with a consumer of the UI component performing a lookup of network addresses (e.g., of the front-end 235) in the domain name service (DNS) 245 (message 1). The consumer can also authenticate (message 2) with an authentication node 240 to, for example, acquire a token used for future interactions. The consumer then makes the request for the UI component to the front-end 235 (message 3B). The consumer can simultaneously make a request to the CDN 230 to acquire static resources (e.g., web pages) that are part of the UI component (message 3A). The request to the front-end 235 can be directed to either the active region cloud 205 or the standby region cloud 225 depending upon conditions. However, as illustrated, the compute node 210 of the active region cloud 205 receives the request for the UI component (message 4B). This results in an invocation of the corresponding microservice (message 4C) that can use the structured storage node 215 (message 4D) or the unstructured storage node 220 (message 4E) to produce a response. The response—e.g., serving the UI component or a function of the UI component—is then communicated back to the consumer. In an example, the compute node 210 causes caching of data, for example, from the unstructured storage node 220, to the CDN 230 (message 4A).

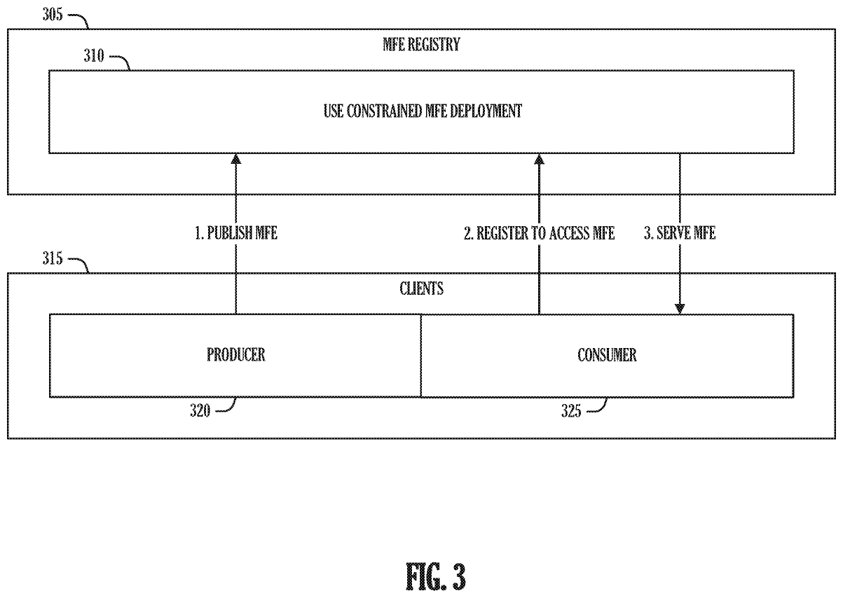

FIG. 3 illustrates examples of signal exchanges to publish and consume user interface components, according to an embodiment. These illustrated components operate on computer devices. For example, the MFE registry 305 can be a collection of compute and storage nodes in the active region cloud 205 illustrated in FIG. 2. The MFE registry 305 is a data storage and processing facility for MFEs. The MFE registry includes a use constrained deployment facility 310 that is configured to accept, maintain, and verify use contexts for MEEs. Accordingly, clients 315, such as a producer 320 (e.g., a developer) and a consumer 325 (e.g., an application integrating an MFE into a UI), communicate with the use constrained deployment facility 310. For example, the producer 320 communicates (message 1) with the use constrained deployment facility 310 to publish an MFE. The consumer 325 communicates (message 2) with the use constrained deployment facility 310 to register an application to use the MFE (e.g., a request for the MFE). The use constrained deployment facility 310 can then govern the serving of MFE components (e.g., static files, data, etc.) (message 3).

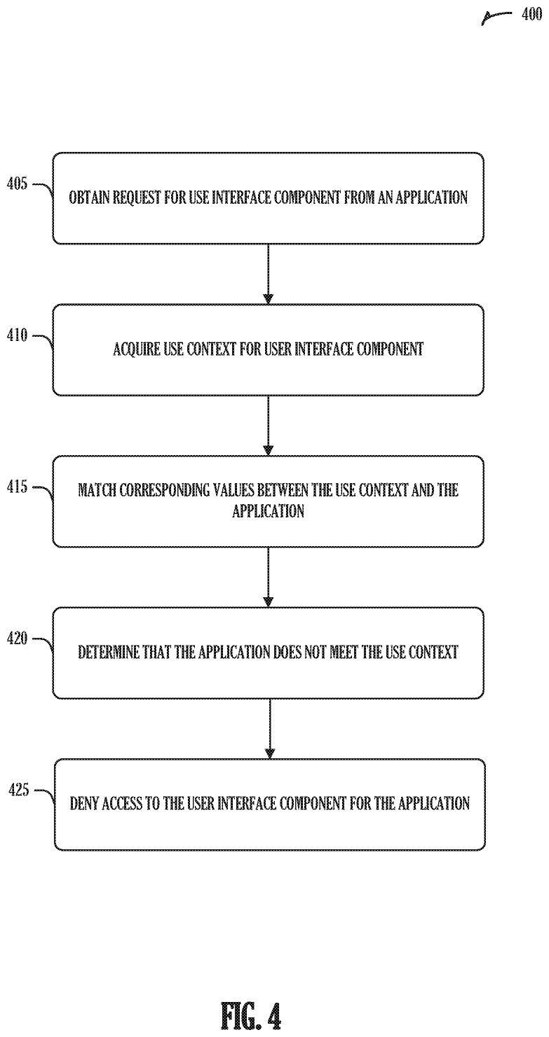

FIG. 4 illustrates a flow diagram of an example of a method 400 for use-constrained user interface component distribution, according to an embodiment. The operations of the method 400 are performed by computer hardware, such as that described above or below (e.g., processing circuitry).

At operation 405 a request for a user interface component (UIC) is received at a system. This request corresponds to a call context that has a first element. The first element has a first field name and a first field value. The UIC is one of multiple UICs hosted by the system. The individual UICs are composable into a user interface. In an example, the UIC is a Web Component based on a World Wide Web Consortium (W3C) family of standards. In an example, the request is based on a Hypertext Transfer Protocol (HTTP) request.

At operation 410, a use context for the UIC is retrieved. The use context includes a second element that has a second field name and a second field value. In an example, the first element and the second element correspond to a physical location. In an example, the first element is a list of other elements in the user interface. In an example, the second element is a list of elements that can be composed with the UIC. In an example, the second element is a list of elements that cannot be composed with the UIC.

At operation 415, the first element is located from the call context based on locating the first field name using the second field name.

At operation 420, the first field value is compared to the second field value to determine that the first field value does not meet the second field value. In an example, the second field value is a range, and wherein the first field value is not within the range. In an example, the second field value is an alphanumeric value, and wherein the first field value has a degree of difference to the alphanumeric value that is beyond a predetermined threshold.

At operation 425, a failure message is transmitted in response to the request based on the first field value not meeting the second field value.

The operations of the method 400 can be extended to include receiving a second request for the UIC, the second request corresponding to a second call context with the first element for an application making the request, the first element including the first field name and a third value. The use context for the UIC can also be retrieved. Then, the first element can be located from the call context based locating the first field name using the second field name and the third value can be compared to the second field value to determine that the third value does meet the second field value. The transmission of the UIC can be enabled based on the third value meeting the second field value.

In an example, the operations of the method 400 can be extended to include recording telemetry of requests for the UIC. In an example, the telemetry includes a representation of an element in the call context. In an example, the telemetry includes a representation of data in the request and not in the call context. In an example, the telemetry includes a representation of data that is not in the request.

The operations of the method 400 can be extended to include receiving a registration request for the UIC, the registration request including the use context. Elements of the use context can be compared with a deployment standard to determine that a third element of the use context does not meet a deployment standard. A failure to register the UIC can be communicated based on the third element not meeting the deployment standard. In an example, the registration request includes source code for a portion of the UIC. In an example, communication of the failure is also based on the source code deviating from the deployment standard. Other elements that the deployment standard can govern include component compatibility, loader types, acceptable libraries, etc.

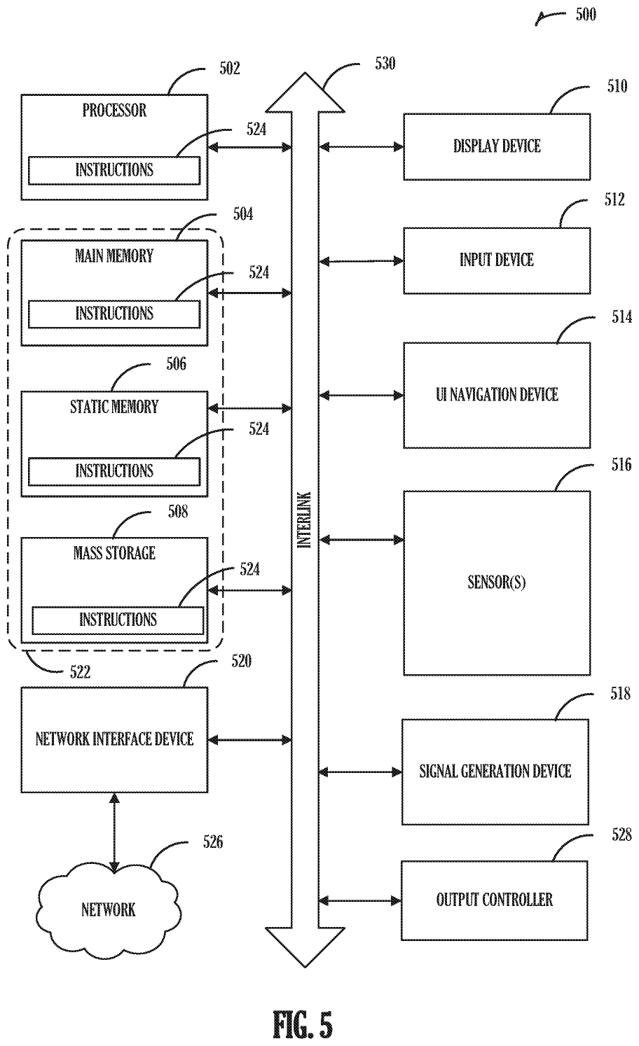

FIG. 5 illustrates a block diagram of an example machine 500 upon which any one or more of the techniques (e.g., methodologies) discussed herein can perform. Examples, as described herein, can include, or can operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 can include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which can communicate with each other via an interlink (e.g., bus) 530. The machine 500 can further include a display unit 510, an alphanumeric input device 512 (e.g., a keyboard), and a user interface (UI) navigation device 514 (e.g., a mouse). In an example, the display unit 510, input device 512 and UI navigation device 514 can be a touch screen display. The machine 500 can additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 can be, or include, a machine readable medium 522 on which is stored one or more sets of data structures or instructions 524 (e.g., software) embodying or utilized by any one or more of the techniques or functions described herein. The instructions 524 can also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 can constitute the machine readable media 522. While the machine readable medium 522 is illustrated as a single medium, the term “machine readable medium” can include a single medium or multiple media (e.g., a centralized or distributed database, and/or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples can include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 can be representative of the instructions 524, such as instructions 524 themselves or a format from which the instructions 524 can be derived. This format from which the instructions 524 can be derived can include source code, encoded instructions (e.g., in compressed or encrypted form), packaged instructions (e.g., split into multiple packages), or the like. The information representative of the instructions 524 in the machine readable medium 522 can be processed by processing circuitry into the instructions to implement any of the operations discussed herein. For example, deriving the instructions 524 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 can include assembly, compilation, or interpretation of the information (e.g., by the processing circuitry) to create the instructions 524 from some intermediate or preprocessed format provided by the machine readable medium 522. The information, when provided in multiple parts, can be combined, unpacked, and modified to create the instructions 524. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 can be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### Additional Notes & Examples

Example 1 is an apparatus for use-constrained user interface component distribution, the apparatus comprising: memory including instructions; and processing circuitry that, when in operation, is configured by the instructions to: receive a request for a user interface component (UIC), the UIC being one of multiple UICs hosted by the apparatus, individual UICs being composable with other UICs into a user interface, the request corresponding to a call context with a first element for an application making the request, the first element including a first field name and a first field value; retrieve, based on receipt of the request for the UIC, a use context corresponding to the UIC, the use context including a second element, the second element including a second field name and a second field value; locate the first element from the call context based on locating the first field name using the second field name; compare the first field value to the second field value to determine that the first field value does not meet the second field value; and transmit a failure message in response to the request based on the first field value not meeting the second field value.

In Example 2, the subject matter of Example 1, wherein the UIC is a Web Component based on a World Wide Web Consortium (Wd3C) family of standards.

In Example 3, the subject matter of Example 2, wherein the request is based on a Hypertext Transfer Protocol (HTTP) request.

In Example 4, the subject matter of any of Examples 1-3, wherein the second field value is a range, and wherein the first field value is not within the range.

In Example 5, the subject matter of any of Examples 1-4, wherein the second field value is an alphanumeric value, and wherein the first field value has a degree of difference to the alphanumeric value that is beyond a predetermined threshold.

In Example 6, the subject matter of any of Examples 1-5, wherein the first element and the second element correspond to a physical location.

In Example 7, the subject matter of any of Examples 1-6, wherein the first element is a list of other elements in the user interface.

In Example 8, the subject matter of Example 7, wherein the second element is a list of elements that are composable with the UIC.

In Example 9, the subject matter of any of Examples 7-8, wherein the second element is a list of elements that cannot be composed with the UIC.

In Example 10, the subject matter of any of Examples 1-9, wherein the processing circuitry is configured to: receive a second request for the UIC, the second request corresponding to a second call context with the first element for an application making the request, the first element including the first field name and a third value; retrieve the use context for the UIC; locate the first element from the call context based locating the first field name using the second field name; compare the third value to the second field value to determine that the third value does meet the second field value; and enable transmission of the UIC based on the third value meeting the second field value.

In Example 11, the subject matter of any of Examples 1-10, wherein the processing circuitry is configured to record telemetry of requests for the UIC.

In Example 12, the subject matter of Example 11, wherein the telemetry includes a representation of an element in the call context.

In Example 13, the subject matter of any of Examples 11-12, wherein the telemetry includes a representation of data in the request and not in the call context.

In Example 14, the subject matter of any of Examples 11-13, wherein the telemetry includes a representation of data that is not in the request.

In Example 15, the subject matter of any of Examples 1-14, wherein the processing circuitry is configured to: receive a registration request for the UIC, the registration request including the use context; compare elements of the use context with a deployment standard to determine that a third element of the use context does not meet a deployment standard; and communicate a failure to register the UIC message based on the third element not meeting the deployment standard.

In Example 16, the subject matter of Example 15, wherein the registration request includes source code for a portion of the UIC, and wherein communication of the failure is also based on the source code deviating from the deployment standard.

Example 17 is a machine readable medium including instructions for use-constrained user interface component distribution, the instructions, when executed by processing circuitry of a system, cause the processing circuitry to perform operations comprising: receiving, at the system, a request for a user interface component (UIC), the UIC being one of multiple UICs hosted by the system, individual UICs being composable with other UICs into a user interface, the request corresponding to a call context with a first element for an application making the request, the first element including a first field name and a first field value; retrieving, based on receipt of the request for the UIC, a use context corresponding to the UIC, the use context including a second element, the second element including a second field name and a second field value; locating the first element from the call context based on locating the first field name using the second field name; comparing the first field value to the second field value to determine that the first field value does not meet the second field value; and transmitting a failure message in response to the request based on the first field value not meeting the second field value.

In Example 18, the subject matter of Example 17, wherein the UIC is a Web Component based on a World Wide Web Consortium (Worm3C) family of standards.

In Example 19, the subject matter of Example 18, wherein the request is based on a Hypertext Transfer Protocol (HTTP) request.

In Example 20, the subject matter of any of Examples 17-19, wherein the second field value is a range, and wherein the first field value is not within the range.

In Example 21, the subject matter of any of Examples 17-20, wherein the second field value is an alphanumeric value, and wherein the first field value has a degree of difference to the alphanumeric value that is beyond a predetermined threshold.

In Example 22, the subject matter of any of Examples 17-21, wherein the first element and the second element correspond to a physical location.

In Example 23, the subject matter of any of Examples 17-22, wherein the first element is a list of other elements in the user interface.

In Example 24, the subject matter of Example 23, wherein the second element is a list of elements that are composable with the UIC.

In Example 25, the subject matter of any of Examples 23-24, wherein the second element is a list of elements that cannot be composed with the UIC.

In Example 26, the subject matter of any of Examples 17-25, wherein the operations comprise: receiving a second request for the UIC, the second request corresponding to a second call context with the first element for an application making the request, the first element including the first field name and a third value; retrieving the use context for the UIC; locating the first element from the call context based locating the first field name using the second field name; comparing the third value to the second field value to determine that the third value does meet the second field value; and enabling transmission of the UIC based on the third value meeting the second field value.

In Example 27, the subject matter of any of Examples 17-26, wherein the operations comprise recording telemetry of requests for the UIC.

In Example 28, the subject matter of Example 27, wherein the telemetry includes a representation of an element in the call context.

In Example 29, the subject matter of any of Examples 27-28, wherein the telemetry includes a representation of data in the request and not in the call context.

In Example 30, the subject matter of any of Examples 27-29, wherein the telemetry includes a representation of data that is not in the request.

In Example 31, the subject matter of any of Examples 17-30, wherein the operations comprise: receiving a registration request for the UIC, the registration request including the use context; comparing elements of the use context with a deployment standard to determine that a third element of the use context does not meet a deployment standard; and communicating a failure to register the UIC message based on the third element not meeting the deployment standard.

In Example 32, the subject matter of Example 31, wherein the registration request includes source code for a portion of the UIC, and wherein communication of the failure is also based on the source code deviating from the deployment standard.

Example 33 is a method for use-constrained user interface component distribution, the method comprising: receiving, at a system, a request for a user interface component (UIC), the UIC being one of multiple UICs hosted by the system, individual UICs being composable with other UICs into a user interface, the request corresponding to a call context with a first element for an application making the request, the first element including a first field name and a first field value; retrieving, based on receipt of the request for the UIC, a use context corresponding to the UIC, the use context including a second element, the second element including a second field name and a second field value; locating the first element from the call context based on locating the first field name using the second field name; comparing the first field value to the second field value to determine that the first field value does not meet the second field value; and transmitting a failure message in response to the request based on the first field value not meeting the second field value.

In Example 34, the subject matter of Example 33, wherein the UIC is a Web Component based on a World Wide Web Consortium (Wm3C) family of standards.

In Example 35, the subject matter of Example 34, wherein the request is based on a Hypertext Transfer Protocol (HTTP) request.

In Example 36, the subject matter of any of Examples 33-35, wherein the second field value is a range, and wherein the first field value is not within the range.

In Example 37, the subject matter of any of Examples 33-36, wherein the second field value is an alphanumeric value, and wherein the first field value has a degree of difference to the alphanumeric value that is beyond a predetermined threshold.

In Example 38, the subject matter of any of Examples 33-37, wherein the first element and the second element correspond to a physical location.

In Example 39, the subject matter of any of Examples 33-38, wherein the first element is a list of other elements in the user interface.

In Example 40, the subject matter of Example 39, wherein the second element is a list of elements that are composable with the UIC.

In Example 41, the subject matter of any of Examples 39-40, wherein the second element is a list of elements that cannot be composed with the UIC.

In Example 42, the subject matter of any of Examples 33-41, comprising: receiving a second request for the UIC, the second request corresponding to a second call context with the first element for an application making the request, the first element including the first field name and a third value; retrieving the use context for the UIC; locating the first element from the call context based locating the first field name using the second field name; comparing the third value to the second field value to determine that the third value does meet the second field value; and enabling transmission of the UIC based on the third value meeting the second field value.

In Example 43, the subject matter of any of Examples 33-42, comprising recording telemetry of requests for the UIC.

In Example 44, the subject matter of Example 43, wherein the telemetry includes a representation of an element in the call context.

In Example 45, the subject matter of any of Examples 43-44, wherein the telemetry includes a representation of data in the request and not in the call context.

In Example 46, the subject matter of any of Examples 43-45, wherein the telemetry includes a representation of data that is not in the request.

In Example 47, the subject matter of any of Examples 33-46, comprising: receiving a registration request for the UIC, the registration request including the use context; comparing elements of the use context with a deployment standard to determine that a third element of the use context does not meet a deployment standard; and communicating a failure to register the UIC message based on the third element not meeting the deployment standard.

In Example 48, the subject matter of Example 47, wherein the registration request includes source code for a portion of the UIC, and wherein communication of the failure is also based on the source code deviating from the deployment standard.

Example 49 is a system for use-constrained user interface component distribution, the system comprising: means for receiving, at the system, a request for a user interface component (UIC), the UIC being one of multiple UICs hosted by the system, individual UICs being composable with other UICs into a user interface, the request corresponding to a call context with a first element for an application making the request, the first element including a first field name and a first field value; means for retrieving, based on receipt of the request for the UIC, a use context corresponding to the UIC, the use context including a second element, the second element including a second field name and a second field value; means for locating the first element from the call context based on locating the first field name using the second field name; means for comparing the first field value to the second field value to determine that the first field value does not meet the second field value; and means for transmitting a failure message in response to the request based on the first field value not meeting the second field value.

In Example 50, the subject matter of Example 49, wherein the UIC is a Web Component based on a World Wide Web Consortium (Wmf3C) family of standards.

In Example 51, the subject matter of Example 50, wherein the request is based on a Hypertext Transfer Protocol (HTTP) request.

In Example 52, the subject matter of any of Examples 49-51, wherein the second field value is a range, and wherein the first field value is not within the range.

In Example 53, the subject matter of any of Examples 49-52, wherein the second field value is an alphanumeric value, and wherein the first field value has a degree of difference to the alphanumeric value that is beyond a predetermined threshold.

In Example 54, the subject matter of any of Examples 49-53, wherein the first element and the second element correspond to a physical location.

In Example 55, the subject matter of any of Examples 49-54, wherein the first element is a list of other elements in the user interface.

In Example 56, the subject matter of Example 55, wherein the second element is a list of elements that are composable with the UIC.

In Example 57, the subject matter of any of Examples 55-56, wherein the second element is a list of elements that cannot be composed with the UIC.

In Example 58, the subject matter of any of Examples 49-57, comprising: means for receiving a second request for the UIC, the second request corresponding to a second call context with the first element for an application making the request, the first element including the first field name and a third value; means for retrieving the use context for the UIC; means for locating the first element from the call context based locating the first field name using the second field name; means for comparing the third value to the second field value to determine that the third value does meet the second field value; and means for enabling transmission of the UIC based on the third value meeting the second field value.

In Example 59, the subject matter of any of Examples 49-58, comprising means for recording telemetry of requests for the UIC.

In Example 60, the subject matter of Example 59, wherein the telemetry includes a representation of an element in the call context.

In Example 61, the subject matter of any of Examples 59-60, wherein the telemetry includes a representation of data in the request and not in the call context.

In Example 62, the subject matter of any of Examples 59-61, wherein the telemetry includes a representation of data that is not in the request.

In Example 63, the subject matter of any of Examples 49-62, comprising: means for receiving a registration request for the UIC, the registration request including the use context; means for comparing elements of the use context with a deployment standard to determine that a third element of the use context does not meet a deployment standard; and means for communicating a failure to register the UIC message based on the third element not meeting the deployment standard.

In Example 64, the subject matter of Example 63, wherein the registration request includes source code for a portion of the UIC, and wherein communication of the failure is also based on the source code deviating from the deployment standard.

Example 65 is at least one machine-readable medium including instructions that, when executed by processing circuitry, cause the processing circuitry to perform operations to implement of any of Examples 1-64.

Example 66 is an apparatus comprising means to implement of any of Examples 1-64.

Example 67 is a system to implement of any of Examples 1-64.

Example 68 is a method to implement of any of Examples 1-64.

The above detailed description includes references to the accompanying drawings, which form a part of the detailed description. The drawings show, by way of illustration, specific embodiments that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A machine readable medium including instructions for use-constrained user interface component distribution, the instructions, when executed by processing circuitry of a system, cause the processing circuitry to perform operations comprising:
receiving, at the system, a request for a user interface component (UIC), the UIC being one of multiple UICs hosted by the system, individual UICs being composable with other UICs into a user interface, the request corresponding to a call context with a first element for an application making the request, the first element including a first field name and a first field value;
retrieving, based on receipt of the request for the UIC, a use context corresponding to the UIC, the use context including a second element, the second element including a second field name and a second field value;
locating the first element from the call context based on locating the first field name using the second field name;
comparing the first field value to the second field value to determine that the first field value does not meet the second field value; and
transmitting a failure message in response to the request based on the first field value not meeting the second field value.

2. The machine readable medium of claim 1, wherein the second field value is a range, and wherein the first field value is not within the range.

3. The machine readable medium of claim 1, wherein the second field value is an alphanumeric value, and wherein the first field value has a degree of difference to the alphanumeric value that is beyond a predetermined threshold.

4. The machine readable medium of claim 1, wherein the first element and the second element correspond to a physical location.

5. The machine readable medium of claim 1, wherein the first element is a list of other elements in the user interface.

6. The machine readable medium of claim 5, wherein the second element is a list of elements that are composable with the UIC.

7. The machine readable medium of claim 5, wherein the second element is a list of elements that cannot be composed with the UIC.

8. The machine readable medium of claim 1, wherein the operations comprise recording telemetry of requests for the UIC.

9. The machine readable medium of claim 1, wherein the operations comprise:
receiving a registration request for the UIC, the registration request including the use context;
comparing elements of the use context with a deployment standard to determine that a third element of the use context does not meet a deployment standard; and
communicating a failure to register the UIC message based on the third element not meeting the deployment standard.

10. The machine readable medium of claim 9, wherein the registration request includes source code for a portion of the UIC, and wherein communication of the failure is also based on the source code deviating from the deployment standard.

11. A method for use-constrained user interface component distribution, the method comprising:
receiving, at a system, a request for a user interface component (UIC), the UIC being one of multiple UICs hosted by the system, individual UICs being composable with other UICs into a user interface, the request corresponding to a call context with a first element for an application making the request, the first element including a first field name and a first field value;
retrieving, based on receipt of the request for the UIC, a use context corresponding to the UIC, the use context including a second element, the second element including a second field name and a second field value;
locating the first element from the call context based on locating the first field name using the second field name;
comparing the first field value to the second field value to determine that the first field value does not meet the second field value; and
transmitting a failure message in response to the request based on the first field value not meeting the second field value.

12. The method of claim 11, wherein the second field value is a range, and wherein the first field value is not within the range.

13. The method of claim 11, wherein the second field value is an alphanumeric value, and wherein the first field value has a degree of difference to the alphanumeric value that is beyond a predetermined threshold.

14. The method of claim 11, wherein the first element and the second element correspond to a physical location.

15. The method of claim 11, wherein the first element is a list of other elements in the user interface.

16. The method of claim 15, wherein the second element is a list of elements that are composable with the UIC.

17. The method of claim 15, wherein the second element is a list of elements that cannot be composed with the UIC.

18. The method of claim 11, comprising recording telemetry of requests for the UIC.

19. The method of claim 11, comprising:
receiving a registration request for the UIC, the registration request including the use context;
comparing elements of the use context with a deployment standard to determine that a third element of the use context does not meet a deployment standard; and
communicating a failure to register the UIC message based on the third element not meeting the deployment standard.

20. The method of claim 19, wherein the registration request includes source code for a portion of the UIC, and wherein communication of the failure is also based on the source code deviating from the deployment standard.
